(19) United States
(12) Patent Application Publication
(10) Pub. No.: US 2007/0028258 A1
(43) Pub. Date: Feb. 1, 2007

(54) Internet protocol television authorization filtering

(75) Inventors: Steve Wollmershauser, San Antonio, TX (US); Yolius Diroo, San Antonio, TX (US); Edward Walter, Boerne, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/189,648

(22) Filed: Jul. 26, 2005

(51) Int. Cl. H04N 7/173; G06F 13/00; G06F 3/00; H04N 7/167; H04N 7/16; H04N 5/445

(52) U.S. Cl. 725/29; 725/113; 725/112; 725/31; 725/46; 725/45

(57) ABSTRACT

The present invention discloses a method and apparatus for authorizing activity in an Internet Protocol Television (IPTV) environment. A requested activity can be a request to view a pay-per-view program or purchase an item. An account server receives a request from a viewer to view or purchase the IPTV activity. The account server checks the cost of the request against a spending limit of the viewer. If the cost of the requested item exceeds the amount available in a viewer's account, the viewer receives a message and is offered an option to request an exception to exceed the spending limit. A request for an exception to exceed the spending limit is received at the account server, and an account administrator is notified of the receipt of the request for the exception. A response is received from the account administrator to grant authorization. If no response is received within a selected time limit, the request can be implicitly rejected.

### BACKGROUND OF THE INVENTION

1. Field of the Invention

The present invention relates to the field of electronic commerce in an interactive Internet Protocol Television (IPTV) environment. In particular, the present invention relates to a method and apparatus for authorizing activity in an IPTV environment.

2. Description of the Related Art

The rapid growth of the Internet has transformed society and changed the way people think about electronic devices. Internet access creates an alternative method to deliver video programming. To a limited extent, the Internet is already used to deliver video programming at a lower cost than existing technology. Internet Protocol Television (IPTV) is a system for transmitting television content over high-speed Internet connections. Conventional television content is usually sent to television sets by way of either cable, satellite, or through the air, in the form of analog or digital signals. Similar to VoIP (Voice over Internet Protocol) for telephonic signals, IPTV sends video data across the Internet in packets of data. This data can then be stored on a server and sent to either computers or special set-top boxes over high speed broad band links such as ADSL (asymmetric digital subscriber lines) or cable. IPTV can be in the form of a live television signal, but is more usually as stored video, facilitating video on demand (VOD). In order to watch IPTV, a person sitting at home needs a computer, or set-top box, plugged into the TV. Where adequate bandwidth exists, IPTV is capable of a rich suite of services compared to cable television or the standard over-the-air distribution.

Purchasable IPTV television services provide television viewers with a plethora of options. In addition to channels that are received and billed on a monthly basis, such as HBO, CNN, etc., some programs or merchandise can be requested by the viewer and billed separately through the television service. One such example of requested programs are pay-per-view (PPV) programs. Typically, pay-per-view programs are associated with events that occur once and are not easily planned into network schedules, such as a live boxing match. Alternatively, a viewer can order a movie and watch the movie at the viewer's convenience. The viewer selects the movie to view, pushes a selection button on a remote control, and the movie is then shown. By selecting the PPV program, the viewer agrees to pay the cost of the program. An itemization of the PPV program shows up on the next monthly bill.

Options are now available to enable households to budget the number of PPV programs viewed per month by maintaining a PPV account. Typically, these PPV accounts are designed to enable parental control via a single account administrator. One way these accounts can be administered is by accessing an account service from the television/cable provider over a local set top box (STB), generally using a remote control device. The administrator of the account enters a password to gain administrative access. Several industries, including Cable TV (CATV) and Satellite television, provide a single spending limit per account. A spending limit enables an account administrator to budget for purchases in a PPV account. Purchases are checked against the spending limit to see that the viewer stays within the budget. There is a need for a more flexible budgeting system for an IPTV account.

### SUMMARY OF THE INVENTION

The present invention discloses a method for authorizing activity (e.g., spending, viewing) in an Internet Protocol Television (IPTV) environment. An account server receives a request from a viewer for a specific activity, such as to view or purchase an IPTV item. AN IPTV item can be a pay-per-view (PPV) program, service, software, or merchandise. The account server checks the cost of the item against an authorization limit for the viewer. The authorization limit is generally enforced by applying a plurality of filters to restrict dollars spent, MPAA rating of program's viewed, time limits on viewing for a viewer's account and activity per period. Each sub-user member or viewer of an IPTV account is assigned one or more authorization filters. These filters generally reside on the account server. A usemame and password are obtained from the viewer in order to apply the correct authorization filters. If the cost or rating of the requested item exceeds the authorization limit specified in a viewer's account, the viewer receives a message and is offered an option to exceed their authorization limit. A request for an exception to exceed the authorization limit is received at the account server, and an account administrator is notified of the receipt of the request for the exception. The request to the account administrator typically comprises the username of the viewer, the item selected for viewing or purchase, and a description, rating and cost for the item. The account server notifies the account administrator using a variety of communication channels, such as by sending an email to one or more email addresses, text messaging or by calling a phone number of the account administrator.

Authorization can be granted through the administrator's response to the notification. Generally, if the account administrator does not respond within the time limit, the request can be implicitly rejected. The account administrator may also pre program certain scenarios for automatic exception authorization when an exception is requested. For example, an administrator can set a soft and hard limit (soft authorization limits=$3.00, MPAA=G; hard authorization limits=$5.00, MPAA=PG-13). Thus, when a soft authorization limit is reached, a request for an exception will be automatically granted if an exception is requested and if the requested activity does not exceed the hard limit. In the above example, a request to view a $5.00 PG-13 movie would be denied initially and subsequently require an exception request, which would be automatically granted. A limit for the number of automatic exceptions can be set a 1, or any number N. A delay (10-20 Minutes) in granting the automatic request can be programmed to emulate seeking and receiving approval of the account administrator.

Other authorization filters are also available for budgeting a IPTV account. For example, a parent can budget a monthly allowance of PPV programs for each of his/her children (account sub users). For example, the parent can select that $10 per month per child to spend on pay-per-view programs. The child could then view five $2 programs or one $10 program before exhausting the budgeted viewing money. Alternatively, the parent can set a monetary limit (i.e., $5 per program) on the price of the individual program that can be selected. Additionally, parents may limit a child's access to programs with high levels of violence, nudity, foul language, etc. using a MPAA (Motion Picture Association of America) rating such as G, PG, PG-13, R, X and NC-17. An authorization limit may also restrict the activity for given time frame (e.g., one movie per day) or restrict activity to a time per period (no movies after 11 pm Sunday through Thursday).

Occasionally, a viewer will exhaust his monthly budgeted amount of purchases but will want to watch another program. When this happens, it becomes necessary to seek an exception the account administrator (i.e. the parent) for permission. Since the content provider tracks the authorization filters, the content provider requires consent to the exception from the account administrator. An account administrator may authorize an exception to a set authorization filter setting (spending limit, MPAA rating, etc.) to allow a sub-user member of the account to exceed their authorization limit.

In one aspect of the invention a method and apparatus are provided method for authorizing activity in an Internet Protocol Television (IPTV) environment wherein the method and apparatus receive an activity request from a viewer for an IPTV activity; check the activity request against a filter for the viewer; and refuse the activity request when the activity exceeds an authorization limit in the filter; receive a request to exceed the authorization limit in the filter; present the request to an account administrator for authorization; and notify the viewer of the authorization. In another aspect of the invention the authorization limit comprises at least one of the set consisting of an MPAA rating, a monetary amount, an activity period and an activity per period limit. In another aspect of the invention the activity comprises at least one of the set consisting of a viewing event and an item purchase. In another aspect of the invention the filter further comprises a plurality of cascaded filters. In another aspect of the invention the request further comprises a viewer username, an activity name, MPAA rating and a cost. In another aspect of the invention notifying an account administrator further comprises contacting the account administrator at one of the set consisting of an email address, text message and a telephone phone number. In another aspect of the invention the method and apparatus import an external authorization limit to the filter from a filter for another viewer. In another aspect of the invention the authorization limit further comprises a hard limit and a soft limit, wherein the method and apparatus automatically grants the authorization request when the activity request exceeds the soft limit but does not exceed the hard limit. In another aspect of the invention a set of application program interfaces are provided comprising a first interface that receives a viewer request for an IPTV activity; a second interface that receives a request to exceed an authorization limit for the viewer; and a third interface that receives authorization for the activity.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 illustrates an exemplary implementation of the present invention;

FIG. 2 illustrates an exemplary display screen showing various filters at an account level;

FIG. 3 illustrates a detailed screen display of an exemplary filter at an individual viewer level;

FIG. 4 illustrates a procedure for administering a budget at the account level and at the viewer level; and

FIG. 5 shows a flowchart for authorizing a viewer to exceed an authorization limit.

### DETAILED DESCRIPTION OF THE INVENTION

In view of the above, the present invention through one or more of its various aspects and/or embodiments is presented to provide one or more advantages, such as those noted below.

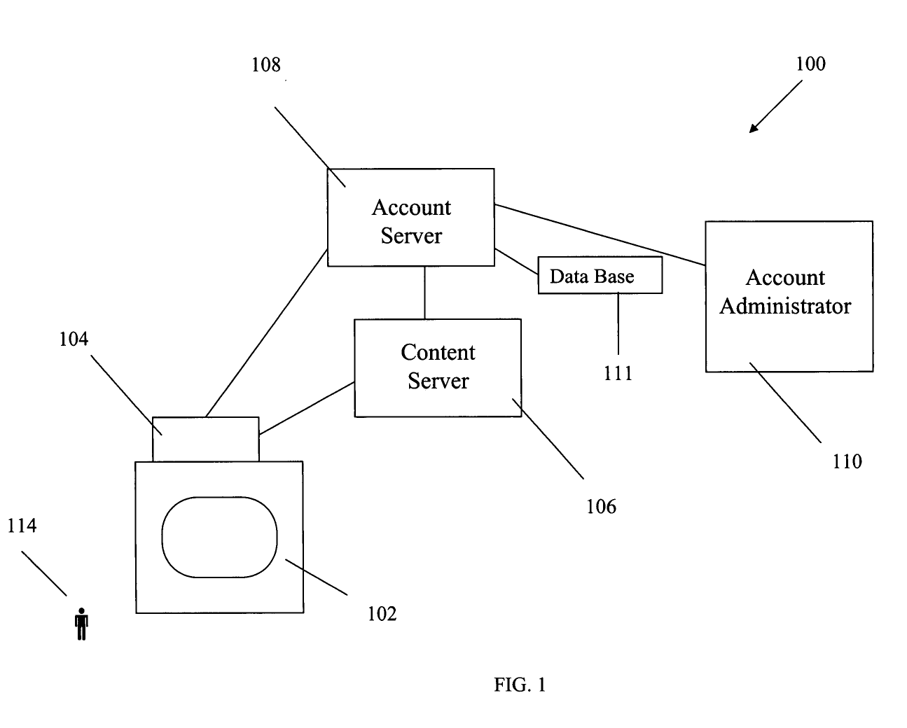

FIG. 1 illustrates an exemplary implementation of the present invention. A television content provider 106, such as an IPTV content provider, provides content to the television 102 by way of a Set Top Box (STB) 104. A viewer at a remote control device 114 typically selects television content using the remote control device 114 communicating with the STB. An account server 108 includes information and s in database 111 used for billing purposes, such as monthly billing information related to requested IPTV items, such as a pay-per-view (PPV) programs. The account server communicates with the STB 104 and tracks the filters and budgets of the viewers. The filters and information can be stored in the set top box, but storing the filters and information on the server provides the advantage of a single storage location accessible to the set top box and the account server. When a viewer selects an IPTV item, he presses a button on a remote control device, and a monetary amount is charged to his account on the account server. If a household account has several sub-accounts (one for each family member), then the viewer enters a usemame and password upon selection of the IPTV item. In this way, the correct sub-account is billed. The account server additionally contains information enabling contact with an account administrator 110. For example, the account server could maintain an email address, a work phone number, a cellular number, etc., of the account administrator. The account administrator is the head of the account, typically a parent of a household. A family unit comprising parents and children is used herein for the purposes of illustration of the present invention. However, it should be understood that the present invention could be used in association with any group of people, such as a fraternity, or a company. The account server communicates with the content server 106 and signals the content server to deliver IPTV content to the viewer.

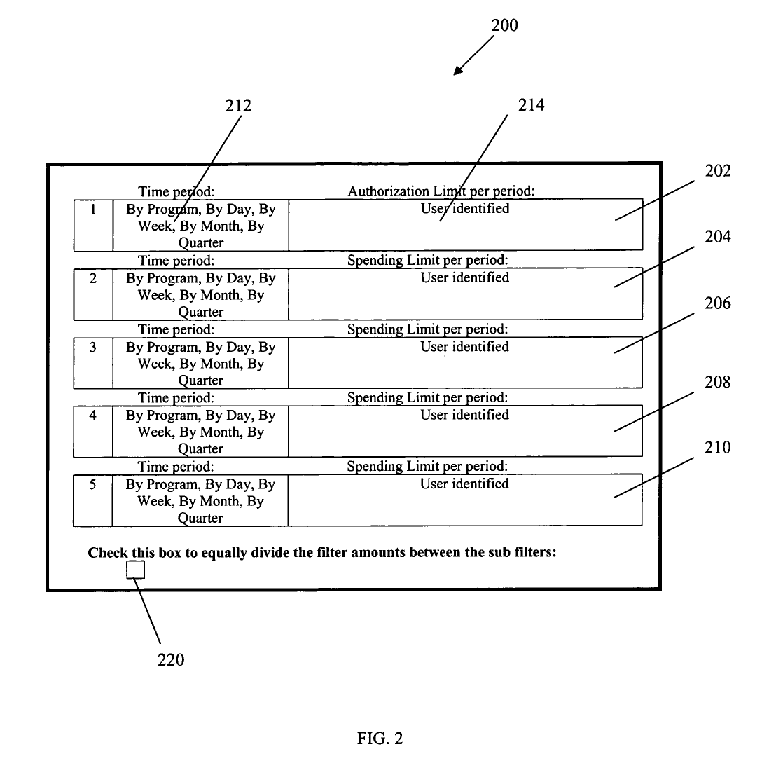

FIG. 2 illustrates an exemplary display screen 200 in one aspect of the present invention showing various filters at an account level. A filter enforces an authorization limit such as a spending limit of a viewer and thereby governs the purchasing and viewing behavior of the viewer. The present invention comprises an application for controlling view activity and budgeting expenses at an account level and at a viewer level. The account level addresses the total amount of money spent by a customer, i.e., a household, and the viewer level controls expenditures of the individual viewers, i.e., family members. One or more filters operate at the account level and a set of sub-filters operates at the individual viewer level. The filters are cascaded so that all authorization filter limits are met.

FIG. 2 displays five filters 202, 204, 206, 208, and 210 used to separately administer authorization limits and viewing budgets for five separate viewers. The filters can be selected in any order, and any time period can be selected for any of the filters.

Filters are commonly activated in order from top to bottom, and the lower filters can be 20 partially hidden from the screen when they are not activated. Each filter has fields for entering criteria which define a budget (dollars/per period) , MPAA rating (G, PG-13, R, X, NC-17), activities per time period (one movie per day, two per week), and time period restrictions (no activity after 11 PM Sunday through Thursday) for a single viewer or household associated with an IPTV account. A spending budget, or spending limit, can be defined, for example, by an amount of money spent per program or an amount of money spent per time period (i.e. by day, by week, by month, by quarter, etc.) The account administrator allots a monetary amount 214 to an apportioned unit 212 to establish the spending limit or budget. In this way, a viewer be budgeted to an expenditure amount (e.g., $2 per program, $10 per week, $25 per month, etc.) Time limits for activities after a cut off are calculated based on the length of the event and it's start time. Thus, a 150 minute movie beginning at 9PM would exceed an authorization limit of 11 PM because the movie would end after 11PM. The movie request could be denied or viewing suspended at 11PM and finished the next day between the hours of 8AM and 11PM as defined by the account administrator in the authorization filter. Viewers may import authorization limits or authority from other users. Authority to import authority from another use is subject to an exception being granted by the account administrator. For example, two family members or viewers may pool their authorization limits of $3.00 each to obtain an authorization limit of $6.00 to purchase a $5.00 movie. In another example, a younger viewer (with an MPAA authorization limit of G) may import an MPAA rating from an older viewer's authorization filter (having an MPAA authorization limit of R) when the two viewers enter their passwords to watch a PG-13 rated movie together. In this scenario, the account administrator may preprogram an automatic grant to the exception or expressly grant or not grant the exception for importing authorization limits when requested.

An additional feature enables the administrator of the account to divide the total amount budgeted for the family equally among its members. The “divide equally” checkbox 220 enables an amount entered at the account level (representing the total amount budgeted for the entire family) to automatically be divided up equally among the filters (i.e. the family members). Although the account administrator can select the “divide equally” button to equally divide the amount between the filters, the account administrator can additionally access each individual filter at the viewer level.

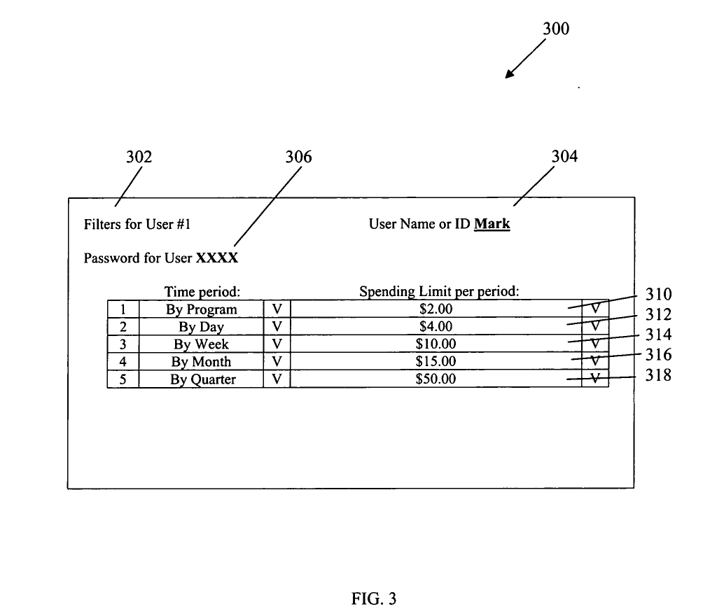

FIG. 3 illustrates a detailed screen display 300 of an exemplary filter at an individual viewer level. The name 304, user number 302, and password 306 of the viewer is indicated on the screen display. Each individual user's password identifies viewer's sub-filters so that individual spending limits can be adjusted. Filter 300 comprises multiple sub-filters. Multiple methods for entering amount in the sub-filters are provided, including drop-down boxes with set monetary amounts. Each sub-filter represents an apportioning unit, such as by program 310, by day 312, by week 314, by month 316, and by quarter 318. The account administrator can determine the amount allotted to each sub-filter. As an example, due to the children's good behavior, a parent awards the children by permitting them a weekly spending limit on television programs, for example, $10 a week. Thus, filter 314 is used ($10 is entered). The parent furthers desires that the children not spend the money on a single $10 pay-per-view program but rather spend the money evenly throughout the week. Thus, filter 310 is used ($2 is entered) to limit the viewer to $2 per program. Therefore, the child can purchase programs up to $2 per program and watch five of these programs over the course of a single week ($10 per week at $2 per program).

When the viewer selects a PPV program, the sub-filters of that viewer are simultaneously consulted to determine whether the viewer has enough money budgeted. Filters are typically consulted in order from longest period amount to shortest period. For the example of FIG. 3, $50 are allotted per quarter 318, and $15 are allotted per month 316. Suppose a viewer has viewed $12 worth of programming in the present month of the present quarter. If the viewer were to request a $5 PPV program, the present invention would first check whether there is enough money allotted in the present quarter. Under the stated supposition, the viewer has $38 remaining to spend on PPV programs in the quarter, so the viewer would be permitted according to the quarterly filter. The present invention would then check whether there is enough money allotted in the present month. Under the stated supposition, the viewer has $3 remaining to spend on PPV programs in this month, so the viewer would not be permitted to view the $5 program. The net result is that the viewer would not be able to purchase the $5 PPV program.

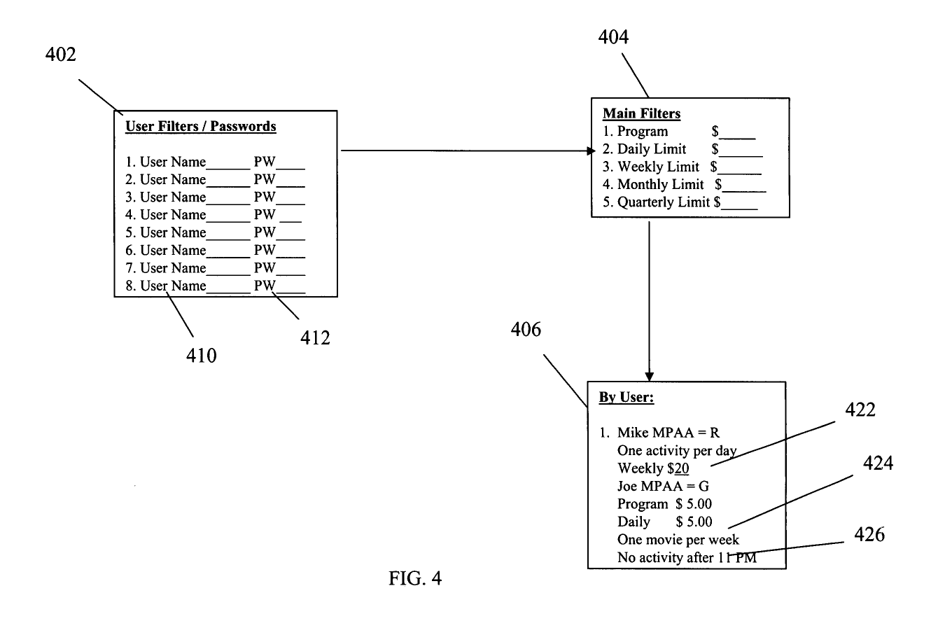

FIG. 4 illustrates a procedure for administering a budget at the account level and at the viewer level. The account administrator assigns each user in the home to a particular filter by adding the user name 410 and selecting a password 412, as shown in display 402. The user then determines the spending limit for the household based on the various filter settings, as in display 404. Filters can be selected on a quarterly, monthly, weekly, and daily basis, as well as on a cost per program basis. The filter limits are then set at the individual viewer level, as in display 406. For example, viewer ‘Mike’ has a weekly filter 422 that budgets him to $20 of purchases per week. Viewer ‘Joe’ has a program filter 424 and a daily filter 426. The program filter 424 budgets him to $5 a program and the daily filter 426 budgets him to purchases that cost no more than $5.

The account administrator can administer the account from any STB using a remote control device. Once administration is complete, configurations are uploaded to a network server, thereby making the spending limits available at the content provider and all the relevant STBs. Thus, individual limits do not need to be set at each STB in the residence. The overall spending limit and individual spending limits are tracked at all the STBs in the residence.

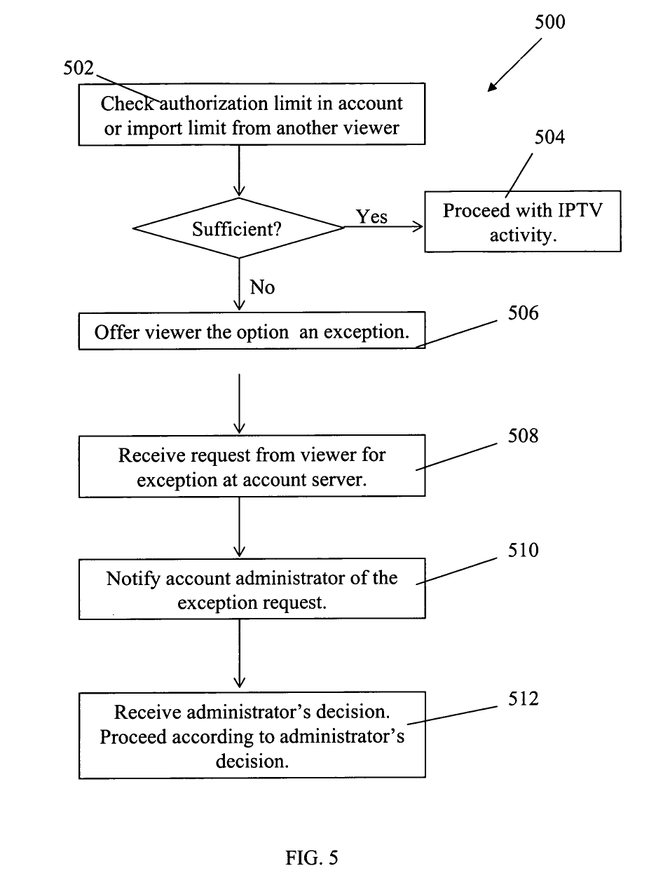

FIG. 5 shows a flowchart of an exemplary aspect of the present invention for authorizing a viewer to exceed an authorization limit such as a spending, MPAA or viewing limit. If so authorized, the viewer is provided with an exception. An exception enables a viewer to exceed his/her authorized limit or budgeted amount upon permission or authorization by the account administrator. The exception applies to a single purchase of an IPTV item, such as a PPV program. Purchasing a second IPTV item that causes the viewer to once again exceed his budget would call for a second exception. Generally, when the viewer attempts to purchase an IPTV item, he indicates his usemame to the account server. The account server determines whether the viewer account balance indicated by the user ID has sufficient funds by checking filters (Box 502). If the funds are sufficient, the IPTV item is provided (Box 504). If funds are insufficient, the account server generates a message back to the viewer offering the viewer an option to request an exception to purchase the IPTV item (Box 506). The viewer then would request the exception (Box 508). The account server, upon receiving the request, notifies the account administrator of a request for an exception (Box 510) by one of the viewers of the account. Notification of the account administrator can be through a variety of media, including email, text messaging and phone number. The email can be sent to multiple email addresses. The email or phone call typically communicates to the account administrator the username of the viewer requesting to purchase the IPTV item as well as the name of the item for which the exception is being requested , account balance and the cost of the requested item. If the administrator is contacted by phone, he can respond to the account server by speaking a response into a voice response system or by pushing an indicated button, such as the ‘1’ button. In order to maintain the integrity of the administrator's response, the account administrator enters an identifying code known to the account administrator. Permission or authorization of the exception can explicitly be granted or rejected by the account administrator. An implicit rejection can also occur if no response is heard from the administrator within a specified period of time. This specified period of time can be a standard period of time set by the content provider or a period of time selected by the administrator. The viewer can be notified to wait for the administrator's response. A timetable can also be established so that the account administrator is not asked for permission at inopportune times, such as when the administrator is unavailable. In such cases, the request for the exception would be rejected. Once the administrator's decision is received (Box 512), the account server proceeds with the appropriate action, i.e. show or don't show the PPV program.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for authorizing activity in an Internet Protocol Television (IPTV) environment, comprising:
receiving an activity request from a viewer for an IPTV activity;
checking the activity request against a filter for the viewer;
refusing the activity request when the activity exceeds an authorization limit in the filter;
receiving a request to exceed the authorization limit in the filter;
presenting the request to an account administrator for authorization; and
notifying the viewer of the authorization.

2. The method of claim 1, wherein the authorization limit comprising at least one of the set consisting of an MPAA rating, a monetary amount, an activity period and an activity per period.

3. The method of claim 1, wherein the activity comprises at least one of the set consisting of a viewing event and an item purchase.

4. The method of claim 1, wherein the filter further comprises a plurality of cascaded filters.

5. The method of claim 1, wherein presenting further comprises supplying at least one of the set consisting of a viewer usemame, an activity name, an account balance, MPAA rating and a cost to the account administrator.

6. The method of claim 1, wherein notifying an account administrator further comprises contacting the account administrator using at least one of the set consisting of an email address, text message and a telephone call.

7. The method of claim 1, further comprising:
importing an authorization limit to the filter.

8. The method of claim 1, wherein the authorization limit further comprises a hard limit and a soft limit, the method further comprising:
automatically granting authorization request in the account administrator when the activity request exceeds the soft limit but does not exceed the hard limit.

9. The method of claim 1, wherein the filter is stored in at least one of the set consisting of a server and a set top box.

10. A computer readable medium containing instructions that when executed by a computer perform a method for authorizing activity in an Internet Protocol Television (IPTV) environment, comprising:
receiving an activity request from a viewer for an IPTV activity;
checking the activity request against a filter for the viewer;
refusing the activity request when the activity exceeds an authorization limit in the filter;
receiving a request to exceed the authorization limit in the filter;
presenting the request to an account administrator for authorization; and
notifying the viewer of the authorization.

11. The medium of claim 10, wherein in the method the authorization limit comprising at least one of the set consisting of an MPAA rating, a monetary amount, an activity period and an activity per period.

12. The medium of claim 10, wherein in the method the activity comprises at least one of the set consisting of a viewing event and an item purchase.

13. The medium of claim 10, wherein in the method the filter further comprises a plurality of cascaded filters.

14. The medium of claim 10, wherein in the method presenting further comprises supplying at least one of the set consisting of a viewer usemame, an activity name, an account balance, MPAA rating and a cost to the account administrator.

15. The medium of claim 10, wherein in the method notifying an account administrator further comprises contacting the account administrator using at least one of the set consisting of an email address, text message and a telephone phone number.

16. The medium of claim 10, the method further comprising:
importing an authorization limit to the filter.

17. The medium of claim 10, wherein in the method the authorization limit further comprises a hard limit and a soft limit, the method further comprising:
automatically granting authorization request in the account administrator when the activity request exceeds the soft limit but does not exceed the hard limit.

18. The medium of claim 10, wherein in the method the filter is stored in at least one of the set consisting of a server and a set top box.

19. A set of application program interfaces embodied on a computer readable medium for execution on a computer in conjunction with an application program in an IPTV environment comprising:
a first interface that receives a viewer request for an IPTV activity;
a second interface that receives a request to exceed an authorization limit for the viewer; and
a third interface that receives authorization for the activity.

20. The set of application program interfaces of claim 19, wherein the authorization limit comprises at least one of the set consisting of an MPAA rating, a monetary amount, an activity period and an activity per period limit.

21. The set of application program interfaces of claim 19, wherein the authorization limit further comprises an imported authorization limit.

22. The set of application program interfaces of claim 19, wherein the authorization limit further comprises a hard limit and a soft limit, wherein the request is automatically granted when the activity request exceeds the soft limit but does not exceed the hard limit.
